(19) United States
(12) Patent Application Publication
(10) Pub. No.: US 2002/0090070 A1
(43) Pub. Date: Jul. 11, 2002

(54) Method and system in a telecommunication system

(76) Inventors: Timo Salonen, Uurainen (FI); Tarmo Hyttinen, Liimattala (FI)

Correspondence Address: ALTERA LAW GROUP, LLC, 6500 CITY WEST PARKWAY, SUITE 100, MINNEAPOLIS, MN, 55344, US

(21) Appl. No.: 09/941,376

(22) Filed: Aug. 28, 2001

Related U.S. Application Data
(63) Continuation of application No. PCT/FI00/00155, filed on Feb. 25, 2000.

(30) Foreign Application Priority Data
Mar. 1, 1999 (FI) 990435

(51) Int. Cl. H04M 15/00

(52) U.S. Cl. 379/114.01; 379/121.04

(57) ABSTRACT

Method and system for locating ambiguities relating to calls in a telecommunication system. In the method, a call is monitored and a call-specific call detailed record is generated about the call, said record containing essential monitoring information. In particular, a new field is added to the call-specific call detailed record and predetermined additional monitoring conditions for the monitoring of call progress is added are set in the call monitoring unit. In addition, a search is performed to find records fulfilling the predetermined additional monitoring conditions and information is added into the new field of the call-specific call detailed record if any of the predetermined monitoring conditions are fulfilled. After this, the call detailed records generated can be transferred for further operation to the control system.

### FIELD OF THE INVENTION

The present invention relates to telecommunication systems. The purpose of the invention is to disclose a new type of method and system that will make it possible to locate service metering records generated from successful calls but containing errors.

### BACKGROUND OF THE INVENTION

In view of their extent, telephone networks, e.g. the public switched telephone network (PSTN), are reliable in operation. Almost all large systems are liable to malfunctions and comprise subsystems or components for the correction of errors. This is the case in telephone networks, too. Various precautions are used to ensure error-free transmission of information.

Monitoring the operation and preventing errors is one of the functions of telephone exchanges. Calls connected and their states are monitored to detect possible errors. Prevention of errors and their immediate correction increase e.g. the operator's reliability in the eyes of the customer. Customer satisfaction will fall significantly if the customer discovers that he has been charged for calls never made or otherwise charged on incorrect grounds.

In telephone exchanges, call monitoring is implemented e.g. so that a call detailed record (CDR) can be generated even during the call. The monitoring conditions may include e.g. the number of pulses and the price and duration of the call. A call detailed record may be generated in a case where the duration or price of the call on hand exceeds a predetermined limit even if the call is terminated normally, i.e. the disconnection code set for the call is zero. This function is called intermediate metering, and it causes the generation of a monitoring report, and in addition an indication of intermediate metering is included in the call detailed record. At present, the operator can use traffic monitoring to monitor calls that have failed for one reason or another. In practice, this may mean setting monitoring conditions for certain call disconnection codes.

The monitoring methods described above cannot be used to monitor calls terminated in the normal manner, i.e. with the disconnection code zero. Consequently, it is not necessarily always possible to locate call detailed records containing information about error situations.

The object of the present invention is to eliminate the drawbacks referred to above or at least to significantly alleviate them.

A specific object of the invention is to disclose a new type of method and system which will make it possible to locate call detailed records generated from normally terminated calls but containing error information. In the method and system of the invention, a search is performed to find metering ambiguities, and if any are found, a corresponding indication is entered in the call detailed record. The invention is not designed to replace the current monitoring system but to extend it and improve its performance and reliability.

As for the features characteristic of the invention, reference is made to the claims.

### SUBJECT OF THE INVENTION

The method of the invention relates to locating metering ambiguities regarding calls and to indicating these in call detailed records. The telecommunication system of the invention preferably comprises a telephone exchange, a call monitoring unit which is part of the telephone exchange, and a control system connected to the telephone exchange. In the system, the call is monitored and a call detailed record is generated from it. If any errors occur during the call, information about them is written in the call detailed record.

In the call monitoring unit, several call monitoring conditions can be set. Some of these are normal permanent conditions which are used to find calls in which errors have occurred. Some of the conditions can be set e.g. by the operator himself. These conditions are not necessarily known to any other parties except the operator. The conditions can be set e.g. using MML commands (MML, Man Machine Language). To allow the above-mentioned call monitoring conditions to be utilized, a new field, which may have the length of one byte, is added to the call detailed record. If any one of a set of predetermined call monitoring conditions is met, then an indication of fulfillment of the condition is written to the call detailed record. The indication may consist of e.g. changing the bit corresponding to the condition to one. If more than one condition are fulfilled for the same call, then the bit corresponding to each condition is set to one. Call detailed records concerning calls can be generated while the call is still going on and also after its termination.

After termination of the call, the call detailed record is sent to the control system for post-processing. Call detailed records containing error information can be sent by the same route as normal error-free records. Another alternative is to send call detailed records containing error information to the control system separately via a predetermined route, a so-called logic file. If ambiguous call detailed records are sent amongst normal records, then the control system must have a property that enables it to sort out the call detailed records containing error information from among the normal records for further examination. If ambiguous call detailed records are sent to the control system via a separate route, then the control system need not be equipped with a sorting-out property because the telephone exchange sorts out the call detailed records before sending them to the control system.

The system of the invention comprises means for adding a new one-byte field to the call-specific call detailed record, means for setting predetermined additional monitoring conditions in a call monitoring unit for monitoring the progress of a call, and means for adding information to the new field in the call detailed record if one or more of the predetermined monitoring conditions are fulfilled.

The system of the invention further comprises means for setting the monitoring conditions for the call monitoring unit using MML commands and means for generating a call detailed record during a call. The system preferably also comprises means for generating a service metering record after termination of a call, means for transferring a call detailed record fulfilling one or more monitoring conditions to the control system along with error-free call detailed records, and means for transferring a call detailed record fulfilling one or more monitoring conditions to the control system via a separate route.

Moreover, the system comprises means for storing a suspicious call detailed record among normal call detailed records and means for storing a suspicious call detailed record in a separate storage for suspicious call detailed records.

In addition to traffic monitoring controlled by the user, call monitoring is used. In call monitoring, the system automatically produces monitoring reports in the following cases:

the number of metering pulses at the end of the call exceeds a monitoring limit,

the system has failed to add the metering pulses to the right counter because of a faulty A-subscriber number or incoming circuit,

intermediate metering is performed on the call.

In call monitoring, the same monitoring report is used as in traffic monitoring.

As compared with prior art, the invention provides the advantage that it allows more effective monitoring of calls classified as successful but still containing an error based on some condition. Thus, the invention has the special advantage that the method of the invention makes it possible to detect errors that could not be detected before. A further advantage is that it allows e.g. the operator to avoid the negative publicity arising from incorrect billing, and in addition the operator can check the metering data and the disturbances having occurred during a given metering period to establish whether the customer has been billed on the wrong grounds.

### LIST OF ILLUSTRATIONS

In the following, the invention will be described in detail by the aid of a few examples of its embodiments, wherein

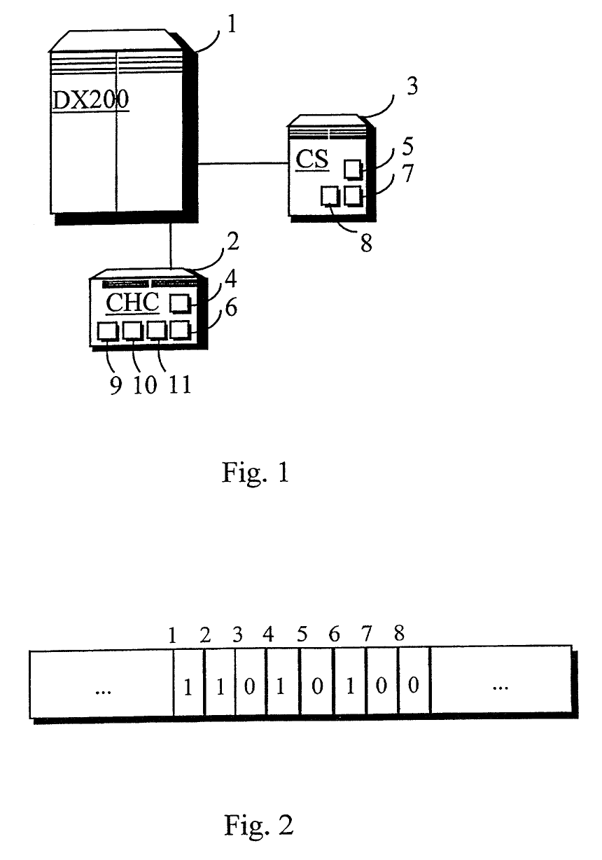

FIG. 1 presents a preferred system according to the invention,

FIG. 2 presents a preferred example of a call detailed record according to the invention, and

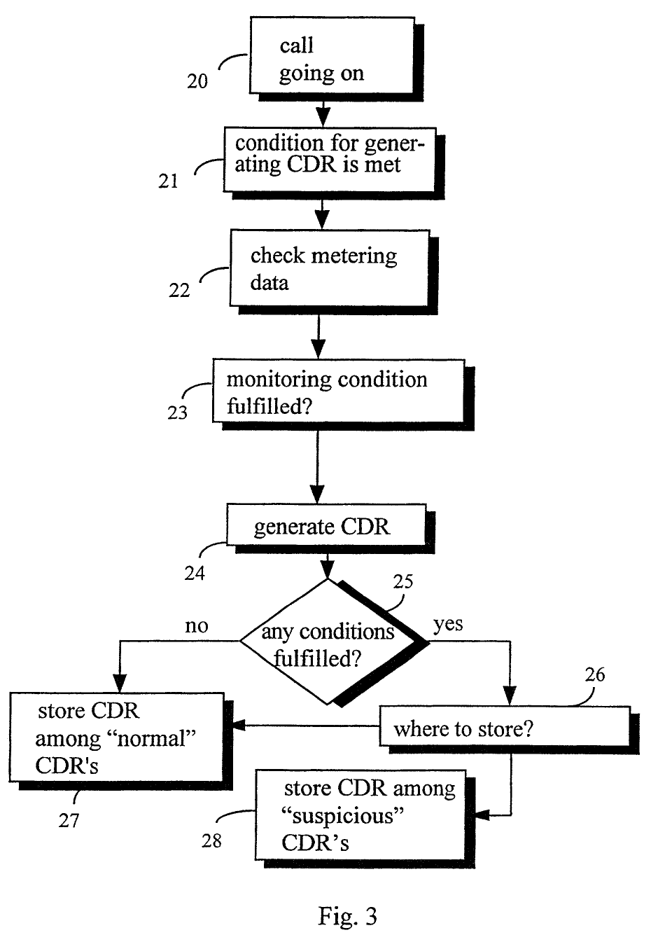

FIG. 3 presents an example of a flow diagram representing the operation of the invention.

### DETAILED DESCRIPTION OF THE INVENTION

The system presented in FIG. 1 comprises a telephone exchange 1, a call monitoring unit 2 (CHC, Charging Handling Computer) connected to the telephone exchange 1 and a control system 3 (CS) connected to the telephone exchange 1. The system comprises means 4 for adding a new one-byte field to a call-specific call detailed record and means 5 for setting predetermined additional monitoring conditions in the call monitoring unit 2 for monitoring the progress of the call. In addition, the system comprises means 6 for adding information into the new field in the call detailed record. Information is added if one or more of the predetermined monitoring conditions are fulfilled.

The system further comprises means 7 for setting the monitoring conditions for the call monitoring unit 2 by using MML commands and means 8 for generating a service metering record during a call. A service metering record can also be generated after the call has been terminated. This case is referred to by means 9. Moreover, the system comprises means 10 for transferring a call detailed record fulfilling one or more monitoring conditions to the control system 3 along with error-free records and means 11 for transferring a call detailed record fulfilling one or more monitoring conditions to the control system 3 via a separate route.

Means 4-11 are implemented as computer software. The means are introduced by the operator.

FIG. 2 presents an example of a call detailed record according to the invention. The call detailed record contains detailed information about the call and also information about the reason why the call detailed record has been generated. In the call detailed record, various information regarding the call and its progress is written to the call detailed record. The information to be written to the record includes e.g. the caller's telephone number, duration of the call and termination code for the call. If the call disconnection code is zero, then the call has been terminated in the normal manner. For error situations, certain predetermined disconnection codes can be defined on the basis of which it is possible to establish what problems have been encountered during or after the call. In the call detailed record presented in FIG. 2, a new one-byte field has been added. Each one of the eight bits in the byte is either 0 or 1. Each bit in the new field corresponds to a given predetermined condition. The first bit could be so defined that it is 1 if the disconnection code for the call was H308. If the second bit is one, this could mean that the duration of the call exceeded 2000 seconds.

In this new field, the operator can set monitoring conditions in addition to the normal monitoring conditions. They are set using MML commands. This new field added to the call detailed record makes it possible to detect errors that could not be detected before. Such errors include e.g. those which have occurred calls disconnected in the normal manner.

FIG. 3 presents a preferred example of a flow diagram representing the operation of the invention. At the beginning of this example, a call is already going on (block 20). A condition for the generation of a call detailed record CDR is fulfilled. In practice, this may mean that the call is terminated or an intermediate metering is to be carried out on the call. Intermediate metering means that e.g. long and/or expensive calls are monitored. These calls may be terminated normally with the disconnection code zero. Based on the metering data obtained about the call, the metering software checks whether the metering data contains any suspicious information (block 22). If any one of the predetermined monitoring conditions is fulfilled (block 23), then the bit corresponding to this monitoring condition is turned “on” in the check_charging field of the CDR in conjunction with the generation of the CDR (block 24). If more than one monitoring conditions are fulfilled for the same call, then the bit corresponding to each condition is turned on in the above-mentioned field.

The call detailed records produced can be stored in two different places depending on whether any monitoring conditions were fulfilled or not (block 25). If no monitoring conditions were fulfilled, then the call detailed record is stored among the “normal” CDR's. In the event that monitoring conditions were fulfilled, there are two alternatives for further action (block 26). The CDR can be stored among the “normal” CDR's (block 27) or the CDR produced can be stored among other “suspicious” CDR's. The choice whether the call detailed record fulfilling monitoring conditions is to be stored among “normal” or “suspicious” CDR's depends on which mode is observed by the telephone exchange.

The invention is not restricted to the examples of its embodiments described above, but many variations are possible within the scope of the inventive idea defined in the claims.

1. Method for locating ambiguities relating to calls in a telecommunication system comprising a telephone exchange (1), a call monitoring unit (2) connected to the telephone exchange (1) and a control system (3) connected to the telephone exchange (1), in which method the call is monitored and a call-specific call detailed record is generated from the call, said record containing essential monitoring information, characterized in that the method comprises the steps of
adding a new field to the call-specific call detailed record;
setting in the call monitoring unit (2) predetermined additional monitoring conditions for the monitoring of call progress;
performing a search to find records fulfilling the predetermined additional monitoring conditions; and
adding information into the new field of the call-specific call detailed record if any of the predetermined monitoring conditions are fulfilled,

2. Method as defined in claim 1, characterized in that the monitoring conditions for the call monitoring unit (2) are set using MML commands.

3. Method as defined in claims 1 and 2, characterized in that a service metering record is generated during the call.

4. Method as defined in claims 1-3, characterized in that a service metering record is generated after the call has been terminated.

5. Method as defined in claims 1-4, characterized in that a call detailed record that fulfills one or more monitoring conditions is transferred to the control system (3) along with error-free call detailed records.

6. Method as defined in claims 1-5, characterized in that a call detailed record fulfilling one or more monitoring conditions is transferred to the control system (3) via a separate route.

7. System for locating ambiguities relating to calls in a telecommunication system comprising a telephone exchange (1), a call monitoring unit (2) forming a part of the telephone exchange (1), a control system (3) connected to the telephone exchange (1), in which system a call is monitored and a call-specific call detailed record is generated from the call, said record containing essential monitoring information, characterized in that the system comprises
means (4) for adding a new field to the call-specific call detailed record;
means (5) for setting in the call monitoring unit (2) predetermined additional monitoring conditions for the monitoring of call progress; and
means (6) for adding information into the new field of the call-specific call detailed record if any of the predetermined monitoring conditions are fulfilled,

8. System as defined in claim 7, characterized in that the system comprises means (7) for setting monitoring conditions for the call monitoring unit (2) using MML commands.

9. System as defined in claims 7 and 8, characterized in that the system comprises means (8) for generating a service metering record during the call.

10. System as defined in claims 7-9, characterized in that the system comprises means (9) for generating a service metering record after the termination of the call.

11. System as defined in claims 7-10, characterized in that the system comprises means (10) for transferring a call detailed record fulfilling one or more monitoring conditions to the control system (3) along with error-free call detailed records.

12. System as defined in claims 7-11, characterized in that the system comprises means (11) for transferring a call detailed record fulfilling one or more monitoring conditions to the control system (3) via a separate route.
